(19) United States
(12) Patent Application Publication
(10) Pub. No.: US 2014/0012499 A1
(43) Pub. Date: Jan. 9, 2014

(54) GUIDING DEVICE, SENSOR UNIT, PORTABLE TERMINAL DEVICE, GUIDING METHOD AND GUIDING PROGRAM

(71) Applicants: Chihiro Hirose, Kawagoe (JP); Shunichiro Nagao, Kawagoe (JP); Isao Endo, Fujimino (JP); Hitoshi Kaneko, Itabashi-ku (JP); Kazuaki Tanaka, Kawagoe (JP)

(72) Inventors: Chihiro Hirose, Kawagoe (JP); Shunichiro Nagao, Kawagoe (JP); Isao Endo, Fujimino (JP); Hitoshi Kaneko, Itabashi-ku (JP); Kazuaki Tanaka, Kawagoe (JP)

(73) Assignee: Pioneer Corporation, Kanagawa (JP)

(21) Appl. No.: 13/985,638

(22) PCT Filed: Mar. 25, 2011
(86) PCT No.: PCT/JP2011/057301

§ 371 Date: Aug. 15, 2013

(51) Int. Cl. G01C 21/28

(52) U.S. Cl. CPC G01C 21/28
USPC 701/470; 455/457

(57) ABSTRACT

A guiding device, includes: a first position detecting unit which detects a present position; an obtaining unit which obtains a present position detected by a second position detecting unit, from a sensor unit having the second position detecting unit which detects the present position; a detecting unit which detects a communication condition with the sensor unit; a determining unit which determines whether to preferentially use the present position detected by the first position detecting unit or the present position detected by the second position detecting unit, based on the communication condition; and a controlling unit which displays a guidance based on the present position determined by the determining unit, on a display unit. Therefore, since the present position can be calculated with accuracy, it becomes possible to appropriately perform the guide based on the present position.

### TECHNICAL FIELD

The present invention relates to a technical field using GPS (Global Positioning System).

### BACKGROUND TECHNIQUE

Conventionally, there is known a technique which calculates a present position based on data received from multiple GPS satellites. For example, in Patent Reference-1, as for a system which supplies and receives information via a communication line between an in-vehicle navigation device and a portable navigation device, there is proposed a technique for displaying a GPS position measurement result obtained from the portable navigation device, on a road map displayed by the in-vehicle navigation device.

### PRIOR ART REFERENCE

### Patent Reference

Patent Reference-1 : Japanese Patent Application Laid-open under No. 07-253327

### SUMMARY OF INVENTION

### Problem to be Solved by the Invention

In recent years, there is proposed a system which includes a portable terminal device having a GPS receiver, and which includes an in-vehicle device that is configured to hold the portable terminal device and that is fixed to the vehicle. Additionally, there is a case that a GPS receiver is built into the in-vehicle device of the said system. As for the above system having multiple GPS receivers, Patent Reference-1 does not describe a method for calculating the present position with accuracy, based on data which the multiple GPS receivers receive.

The present invention has been achieved in order to solve the above problem. It is an object of the present invention to provide a guiding device, a sensor unit, a portable terminal device, a guiding method and a guiding program, capable of calculating a present position with accuracy based on data which multiple GPS receivers receive.

### Means for Solving the Problem

In the invention according to claim 1, a guiding device, includes : a first position detecting unit which detects a present position; an obtaining unit which obtains a present position detected by a second position detecting unit, from a sensor unit having the second position detecting unit which detects the present position; a detecting unit which detects a communication condition with the sensor unit; a determining unit which determines whether to preferentially use the present position detected by the first position detecting unit or the present position detected by the second position detecting unit, based on the communication condition; and a controlling unit which displays a guidance based on the present position determined by the determining unit, on a display unit.

In the invention according to claim 7, a sensor unit, includes: a position detecting unit which detects a present position; a supplementary information detecting unit which detects supplementary information that is supplementally used for detecting the present position; a communication unit which communicates with a guiding device having a guiding function; and a fixing unit which fixes the sensor unit to a movable body, wherein the sensor unit calculates position information based on the present position detected by the position detecting unit and/or the supplementary information detected by the supplementary information detecting unit, and sends the position information to the guiding device via the communication unit.

In the invention according to claim 8, a guiding method executed by a guiding device, includes: a first position detecting process which detects a present position; an obtaining process which obtains a present position detected by a second position detecting unit, from a sensor unit having the second position detecting unit which detects the present position; a detecting process which detects a communication condition with the sensor unit; a determining process which determines whether to preferentially use the present position detected by the first position detecting process or the present position detected by the second position detecting unit, based on the communication condition; and a controlling process which displays a guidance based on the present position determined by the determining process, on a display unit.

In the invention according to claim 9, a guiding program executed by a guiding device having a computer, the program makes the computer function as: a first position detecting unit which detects a present position; an obtaining unit which obtains a present position detected by a second position detecting unit, from a sensor unit having the second position detecting unit which detects the present position; a detecting unit which detects a communication condition with the sensor unit; a determining unit which determines whether to preferentially use the present position detected by the first position detecting unit or the present position detected by the second position detecting unit, based on the communication condition; and a controlling unit which displays a guidance based on the present position determined by the determining unit, on a display unit.

In the invention according to claim 10, a portable terminal device, includes: a first position detecting unit which detects a present position by a GPS position measurement; a displaying unit which displays a navigation guide screen; a communication unit which is fixed to a movable body, and communicates with a sensor unit that includes a second position detecting unit which detects a present position by a GPS position measurement and that includes a sensor which detects a condition of the movable body; and a detecting unit which detects a communication condition with the sensor unit, wherein, when the communication condition detected by the detecting unit is good, the portable terminal device prioritizes position information calculated based on the present position detected by the second position detecting unit and/or the condition of the movable body detected by the sensor which are received from the sensor unit, over the present position detected by the first position detecting unit, and preferentially uses the position information at the time of displaying the navigation guide screen.

In the invention according to claim 11, a sensor unit being fixed to a movable body, includes : a position detecting unit which detects a present position by a GPS position measurement; a sensor which detects a condition of the movable body; and a communication unit which communicates with a portable terminal device having a navigation function, wherein the sensor unit calculates position information based on the present position detected by the position detecting unit and/or the condition of the movable body detected by the sensor, and sends the position information to the portable terminal device via the communication unit.

### BRIEF DESCRIPTION OF THE DRAWINGS

FIG. 1 is a block diagram showing a schematic configuration of a guiding device and a sensor unit in an embodiment.

FIG. 2 shows a processing flow executed by a controlling unit in a guiding device, in a first embodiment.

FIG. 3 shows a processing flow executed by a controlling unit in a sensor unit, in a first embodiment.

FIG. 4 shows a processing flow executed by a controlling unit in a guiding device, in a second embodiment.

FIGS. 5A and 5B are diagrams showing display screens in a first modified example.

### MODE TO EXERCISE THE INVENTION

According to one aspect of the present invention, there is provided a guiding device, including: a first position detecting unit which detects a present position; an obtaining unit which obtains a present position detected by a second position detecting unit, from a sensor unit having the second position detecting unit which detects the present position; a detecting unit which detects a communication condition with the sensor unit; a determining unit which determines whether to preferentially use the present position detected by the first position detecting unit or the present position detected by the second position detecting unit, based on the communication condition; and a controlling unit which displays a guidance based on the present position determined by the determining unit, on a display unit.

The above guiding device is preferably used for executing a route guide (i.e., navigation) from a departure place to a destination. The guiding device communicates with the sensor unit having the second position detecting unit. The first position detecting unit detects the present position, and the obtaining unit obtains the present position detected by the second position detecting unit, from the sensor unit, and the detecting unit detects the communication condition with the sensor unit. For example, the first and second position detecting units detect the present position by a GPS position measurement. The determining unit determines whether to preferentially use the present position detected by the first position detecting unit or the present position detected by the second position detecting unit, based on the communication condition with the sensor unit. Then, the controlling unit which displays the guidance based on the present position determined by the determining unit, on the display unit. According to the above guiding device, in accordance with the communication condition, the second position detecting unit is used in addition to the first position detecting unit. Therefore, compared to a configuration using only the first position detecting unit, it is possible to calculate the present position with accuracy. This is because, since the second position detecting unit is provided with the sensor unit, there is a lot of flexibility related to a size and an installation position of the second position detecting unit compared to the first position detecting unit. Hence, it becomes possible to appropriately perform the guide based on the calculated present position.

In one mode of the above guiding device, the guiding device further includes a comparing unit which compares reliability of a detection by the first position detecting unit with reliability of a detection by the second position detecting unit, and the determining unit determines whether to preferentially use the present position detected by the first position detecting unit or the present position detected by the second position detecting unit, based on the communication condition and a comparison result by the comparing unit.

According to the above mode, the guiding device can preferentially use one of the first and second position detecting units, the reliability of the detection of which is higher than that of the other. Therefore, it becomes possible to calculate the present position with higher accuracy.

In another mode of the above guiding device, the guiding device further includes a supplementary information obtaining unit which obtains supplementary information that is supplementally used for detecting the present position, from the sensor unit which is fixed to a movable body, and, when the reliability of the detection by the first position detecting unit is higher than the reliability of the detection by the second position detecting unit, the controlling unit displays the guidance on the display unit based on the present position detected by the first position detecting unit and the supplementary information.

According to the above mode, the guiding device obtains the supplementary information which is supplementally used for detecting the present position, from the sensor unit being fixed to the movable body. For example, the supplementary information is acceleration detected by an acceleration sensor and an angular velocity detected by a gyro sensor. When the reliability of the detection by the first position detecting unit is higher than the reliability of the detection by the second position detecting unit, the guiding device calculates the present position based on the present position detected by the first position detecting unit and the supplementary information. Namely, the guiding device calculates the present position by adding the supplementary information to the present position detected by the first position detecting unit. Therefore, it becomes possible to calculate the present position with higher accuracy.

In still another mode of the above guiding device, the supplementary information includes information indicating a direction, and the controlling unit displays the guidance on the display unit by using the direction included in the supplementary information as a present direction.

According to the above mode, the guiding device uses the direction included in the supplementary information obtained from the sensor unit, as the present direction. This is because, since the sensor unit is fixed to the movable body, it can be said that the direction detected by the sensor unit has high accuracy.

In still another mode of the above guiding device, the guiding device further includes a supplementary information obtaining unit which obtains supplementary information that is supplementally used for detecting the present position, from the sensor unit which is fixed to a movable body, and, when the present position cannot be detected by the first position detecting unit and the second position detecting unit, the controlling unit displays the guidance on the display unit based on present position information used last time and the supplementary information.

According to the above mode, even if the present position cannot be obtained from the first and second position detecting units, the guiding device can calculate the present position. For example, when both the reliability of the first position detecting unit and the reliability of the second position detecting unit are low, an acceptable present position cannot be detected. Additionally, while the position detecting units continually detects the present position at a predetermined time interval, the present position cannot be obtained from the first and second position detecting units during a time period when the position detecting units do not detect the present position.

In still another mode of the above guiding device, in accordance with a determination by the determining unit, the controlling unit displays information as to whether to preferentially use the present position detected by the first position detecting unit or the present position detected by the second position detecting unit, on the display unit.

According to the above mode, the user can easily make out whether to preferentially use the present position detected by the first position detecting unit or the present position detected by the second position detecting unit.

According to another aspect of the present invention, there is provided a sensor unit, including: a position detecting unit which detects a present position; a supplementary information detecting unit which detects supplementary information that is supplementally used for detecting the present position; a communication unit which communicates with a guiding device having a guiding function; and a fixing unit which fixes the sensor unit to a movable body, the sensor unit calculates position information based on the present position detected by the position detecting unit and/or the supplementary information detected by the supplementary information detecting unit, and sends the position information to the guiding device via the communication unit.

The sensor unit communicates with the above-mentioned guiding device by the communication unit. Additionally, the sensor unit is fixed to the movable body by the fixing unit. The position detecting unit detects the present position by the GPS position measurement, for example, and the supplementary information detecting unit detects the supplementary information which is supplementally used for detecting the present position. For example, the supplementary information detecting unit corresponds to the acceleration sensor and the gyro sensor. Then, the sensor unit calculates the position information based on the present position detected by the position detecting unit and/or the supplementary information, and sends the calculated position information to the guiding device. The position information includes a latitude, a longitude, a velocity, an altitude, a direction and acceleration. By the above sensor unit, since the guiding device can obtain the position information having high accuracy, the guiding device can appropriately perform the guide based on the present position.

According to still another aspect of the present invention, there is provided a guiding method executed by a guiding device, including: a first position detecting process which detects a present position; an obtaining process which obtains a present position detected by a second position detecting unit, from a sensor unit having the second position detecting unit which detects the present position; a detecting process which detects a communication condition with the sensor unit; a determining process which determines whether to preferentially use the present position detected by the first position detecting process or the present position detected by the second position detecting unit, based on the communication condition; and a controlling process which displays a guidance based on the present position determined by the determining process, on a display unit.

According to still another aspect of the present invention, there is provided a guiding program executed by a guiding device having a computer, the program makes the computer function as: a first position detecting unit which detects a present position; an obtaining unit which obtains a present position detected by a second position detecting unit, from a sensor unit having the second position detecting unit which detects the present position; a detecting unit which detects a communication condition with the sensor unit; a determining unit which determines whether to preferentially use the present position detected by the first position detecting unit or the present position detected by the second position detecting unit, based on the communication condition; and a controlling unit which displays a guidance based on the present position determined by the determining unit, on a display unit.

By the above guiding method and the guiding program, since the present position can be calculated with accuracy, it becomes possible to appropriately perform the guide based on the present position.

According to still another aspect of the present invention, there is provided a portable terminal device, including: a first position detecting unit which detects a present position by a GPS position measurement; a displaying unit which displays a navigation guide screen; a communication unit which is fixed to a movable body, and communicates with a sensor unit that includes a second position detecting unit which detects a present position by a GPS position measurement and a sensor which detects a condition of the movable body; and a detecting unit which detects a communication condition with the sensor unit, when the communication condition detected by the detecting unit is good, the portable terminal device prioritizes position information calculated based on the present position detected by the second position detecting unit and/or the condition of the movable body detected by the sensor which are received from the sensor unit, over the present position detected by the first position detecting unit, and preferentially uses the position information at the time of displaying the navigation guide screen.

According to still another aspect of the present invention, there is provided a sensor unit being fixed to a movable body, including: a position detecting unit which detects a present position by a GPS position measurement; a sensor which detects a condition of the movable body; and a communication unit which communicates with a portable terminal device having a navigation function, the sensor unit calculates position information based on the present position detected by the position detecting unit and/or the condition of the movable body detected by the sensor, and sends the position information to the portable terminal device via the communication unit.

### Embodiment

The preferred embodiments of the present invention will now be described below with reference to the drawings.

### [System Configuration]

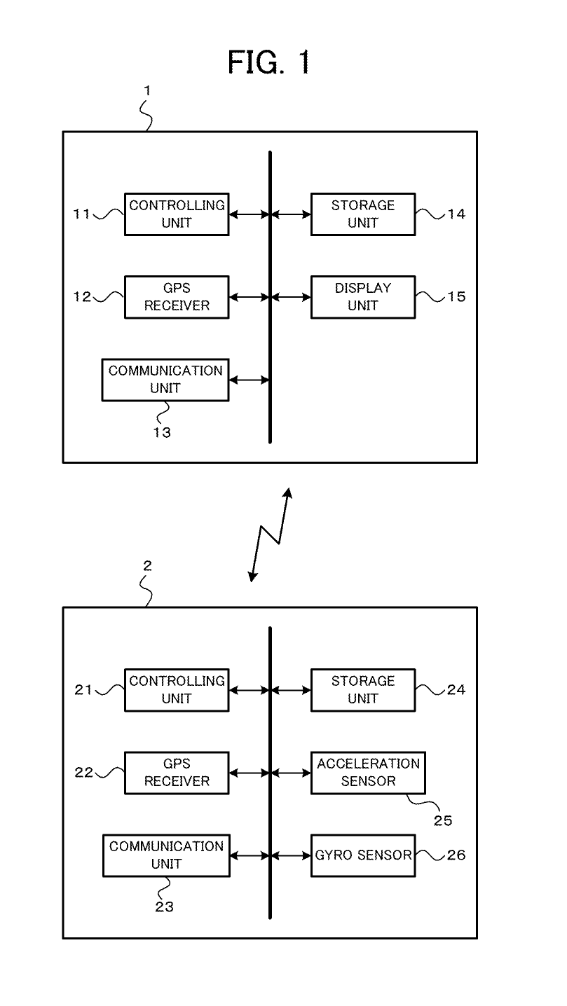

FIG. 1 is a block diagram showing a schematic configuration of a guiding device 1 and a sensor unit 2 in a present embodiment.

The guiding device 1 mainly includes a controlling unit 11, a GPS receiver 12, a communication unit 13, a storage unit 14 and a display unit 15. For example, the guiding device 1 is a portable terminal device such as a smartphone having a verbal communication function. Additionally, the guiding device 1 performs a route guide (i.e., navigation) from a departure place to a destination, for example. Other than the components shown in FIG. 1, the guiding device 1 includes an operation unit operated by a user, a communication unit for communicating with other guiding device 1, a speaker and a microphone (which are not shown).

The GPS receiver 12 receives an electric wave for transmitting downlink data including position measurement data from multiple GPS satellites, via an antenna which is not shown. The data received by the GPS receiver 12 is used for calculating a present position of the guiding device 1. The GPS receiver 12 corresponds to an example of the “first position detecting unit” in the present invention.

The communication unit 13 is configured to be able to perform wireless communication with the sensor unit 2 (specifically, a communication unit 23 in the sensor unit 2). For example, the communication unit 13 performs the wireless communication using Bluetooth (registered trademark). The communication unit 13 corresponds to an example of the “obtaining unit”, the “communication unit”, the “supplementary information obtaining unit” and “fixed condition information obtaining unit” in the present invention.

The display unit 15 is a liquid crystal display, for example, and displays characters and images to the user.

The storage unit 14 includes a ROM and a RAM. The storage unit 14 stores control program for controlling the guiding device 1, and provides a working area for the controlling unit 11.

The controlling unit 11 includes a CPU, and executes control of the guiding device 1 in its entirety. For example, the controlling unit 11 executes processing related to the route guide from the departure place to the destination. The controlling unit 11 corresponds to an example of the “controlling unit”, the “determining unit”, the “comparing unit” and the “detecting unit” in the present invention.

On the other hand, the sensor unit 2 mainly includes a controlling unit 21, a GPS receiver 22, a communication unit 23, a storage unit 24, an acceleration sensor 25 and a gyro sensor 26. The sensor unit 2 is fixed to a movable body such as a vehicle (for example, the sensor unit 2 is fixed to a dashboard of the vehicle), and is configured to be able to hold the guiding device 1. The sensor unit 2 corresponds to an in-vehicle device. When the guiding device 1 is used in the vehicle, it is not limited to use the guiding device 1 in a state held by the sensor unit 2.

The GPS receiver 22 receives the electric wave for transmitting the downlink data including the position measurement data from the multiple GPS satellites, via the antenna which is not shown. The data received by the GPS receiver 22 is used for calculating the present position of the sensor unit 2 (i.e., the present position of the vehicle). The GPS receiver 22 corresponds to the “second position detecting unit” and the “position detecting unit” in the present invention. Here, the antenna of the GPS receiver 22 is larger than the antenna of the GPS receiver 12 in the guiding device 1. This is because the sensor unit 2 has little restriction of space compared to the guiding device 1.

The communication unit 23 is configured to be able to perform the wireless communication with the guiding device 1 (specifically, the communication unit 13 in the guiding device 1). For example, the communication unit 23 performs the wireless communication using Bluetooth (registered trademark). The communication unit 23 corresponds to an example of the “communication unit” in the present invention.

The acceleration sensor 25 detects acceleration of the vehicle, and outputs acceleration data. The gyro sensor 26 detects an angular velocity in a yaw direction at the time of changing the direction of the vehicle, and outputs angular velocity data. The acceleration and the angular velocity detected by the acceleration sensor 25 and the gyro sensor 26 correspond to an example of the “supplementary information” which is supplementally used for detecting the present position. Namely, the acceleration sensor 25 and the gyro sensor 26 correspond to an example of the “supplementary information detecting unit” in the present invention. In other words, the acceleration sensor 25 and the gyro sensor 26 correspond to an example of the “sensor” which detects the condition of the movable body.

The storage unit 24 includes a ROM and a RAM. The storage unit 24 stores the control program for controlling the sensor unit 2, and provides the working area for the controlling unit 21.

The controlling unit 21 includes a CPU, and executes control of the sensor unit 2 in its entirety. For example, the controlling unit 21 executes processing for estimating the present position based on data obtained from the GPS receiver 22 and/or the above sensors. Then, the controlling unit 21 sends information related to the estimated present position to the guiding device 1 via the communication unit 23.

### [Controlling Method]

Next, a description will be given of a controlling method executed by the controlling unit 11 in the guiding device 1 and the controlling unit 21 in the sensor unit 2 in the embodiment. Here, a brief description will be given of a basic concept of the controlling method in the embodiment.

In the embodiment, the controlling unit 11 in the guiding device 1 calculates the position information related to the present position based on information obtained inside the guiding device 1 and information received from the sensor unit 2. The “position information” includes a latitude, a longitude, a velocity, an altitude, a direction and acceleration. Concretely, the controlling unit 11 preferentially uses either position information calculated based on data which the GPS receiver 12 in the guiding device 1 receives or position information received from the sensor unit 2, so as to execute the route guide. Specifically, the controlling unit 11 determines the position information to be used for the route guide, based on whether or not the guiding device 1 can perform the wireless communication with the sensor unit 2, and based on a reception condition (hereinafter arbitrarily referred to as “GPS reception condition”) of the GPS receiver 12 in the guiding device 1 and the GPS receiver 22 in the sensor unit 2.

On the other hand, the controlling unit 21 in the sensor unit 2 calculates position information based on data which the GPS receiver 22 receives and the acceleration and the angular velocity detected by the acceleration sensor 25 and the gyro sensor 26. Then, the controlling unit 21 sends the calculated position information to the guiding device 1 via the communication unit 23.

Concrete embodiments of the above controlling method will be described below.

### First Embodiment

In a first embodiment, when the guiding device 1 can perform the wireless communication with the sensor unit 2, the controlling unit 11 in the guiding device 1 uses the position information received from the sensor unit 2 (i.e., the position information calculated by the sensor unit 2), so as to execute the route guide. Meanwhile, when the guiding device 1 cannot perform the wireless communication with the sensor unit 2, the controlling unit 11 in the guiding device 1 uses the position information calculated based on the data which the GPS receiver 12 in the guiding device 1 receives, so as to execute the route guide.

On the other hand, when the GPS reception condition of the GPS receiver 22 is good, the controlling unit 21 in the sensor unit 2 calculates the position information based on at least the data which the GPS receiver 22 receives. Meanwhile, when the GPS reception condition of the GPS receiver 22 is not good, the controlling unit 21 calculates the position information based on the position information used last time and the acceleration and the angular velocity detected by the acceleration sensor 25 and the gyro sensor 26. Then, the controlling unit 21 sends the calculated position information to the guiding device 1.

The reason for executing the above controlling method is as follows. If only the GPS receiver 12 in the guiding device 1 is used (the GPS receiver 22 in the sensor unit 2 is not used), it is difficult to estimate the correct position when the GPS receiver 12 can not be appropriately used due to a multipath phenomenon or such a state that it is difficult to receive the electric wave. Meanwhile, since space which can be used in the guiding device 1 as the portable terminal device is limited, a GPS antenna having a large size cannot be built into the guiding device 1. Therefore, as for the guiding device 1, it is difficult to increase a sensitivity of the GPS receiver 12. Thus, as for the configuration only using the GPS receiver 12 in the guiding device 1, since the correct position cannot be estimated, there is a possibility to perform the guide of the navigation with wrong timing or to display a route from a wrong position. When the guiding device 1 is used in a passenger seat or a backseat, since there is a roof above these seats, there is a high possibility that the correct position cannot be estimated due to decrease in receiving sensitivity of the GPS.

On the other hand, there is a method for dealing with the above problem by building the acceleration sensor and the gyro sensor in the guiding device 1. However, in the said method, since it is necessary to fix the guiding device 1 to the vehicle as the movable body, it can be said to hamper a convenience of the guiding device 1 as the portable terminal device. The reason why it is necessary to fix the guiding device 1 to the vehicle is as follows. For example, if the guiding device 1 is not fixed to the vehicle, the guiding device 1 itself moves backward at the time of applying the acceleration to the guiding device 1 in posterior direction of the vehicle, and then the acceleration applied to the acceleration sensor decreases. In contrast, if the user moves the guiding device 1 itself backward even when the vehicle does not accelerate, the acceleration sensor detects the acceleration.

Thus, in the first embodiment, the guiding device 1 calculates the position information by using the multiple GPS receivers (concretely, the GPS receiver 12 in the guiding device 1 and the GPS receiver 22 in the sensor unit 2), in accordance with the communication condition of the guiding device 1 and the sensor unit 2. Namely, the guiding device 1 uses not only the GPS receiver 12 in the guiding device 1 but also the GPS receiver 22 in the sensor unit 2, the antenna of which is larger than that of the GPS receiver 12. Additionally, in the first embodiment, the sensor unit 2 being fixed to the vehicle calculates the position information based on the data which the GPS receiver 22 receives, and calculates the position information by applying the acceleration and the angular velocity detected by the acceleration sensor 25 and the gyro sensor 26 to the data which the GPS receiver 22 receives. Then, the guiding device 1 receives the calculated position information from the sensor unit 2 by the wireless communication.

Therefore, compared to the configuration only using the GPS receiver 12 in the guiding device 1, since the multiple GPS receivers (the GPS receiver 12 in the guiding device 1 or the GPS receiver 22 in the sensor unit 2) can be used, it becomes possible to calculate the present position with accuracy. Additionally, since the position information can be obtained from the fixed sensor unit 2 by the wireless communication even if the guiding device 1 is not fixed to the vehicle, it becomes possible to calculate the present position with higher accuracy, by using the various information detected by the acceleration sensor 25 and the gyro sensor 26. As a result, it becomes possible to suppress performing the guide of the navigation with the wrong timing and to suppress displaying the route from the wrong position.

Furthermore, according to the first embodiment, since the position information is sent from the sensor unit 2 to the guiding device 1 by using the wireless communication, it becomes possible to calculate the present position with accuracy despite the position where the guiding device 1 is used in the vehicle. For example, even if the guiding device 1 is used in the passenger seat or the backseat, it is possible to calculate the present position with accuracy.

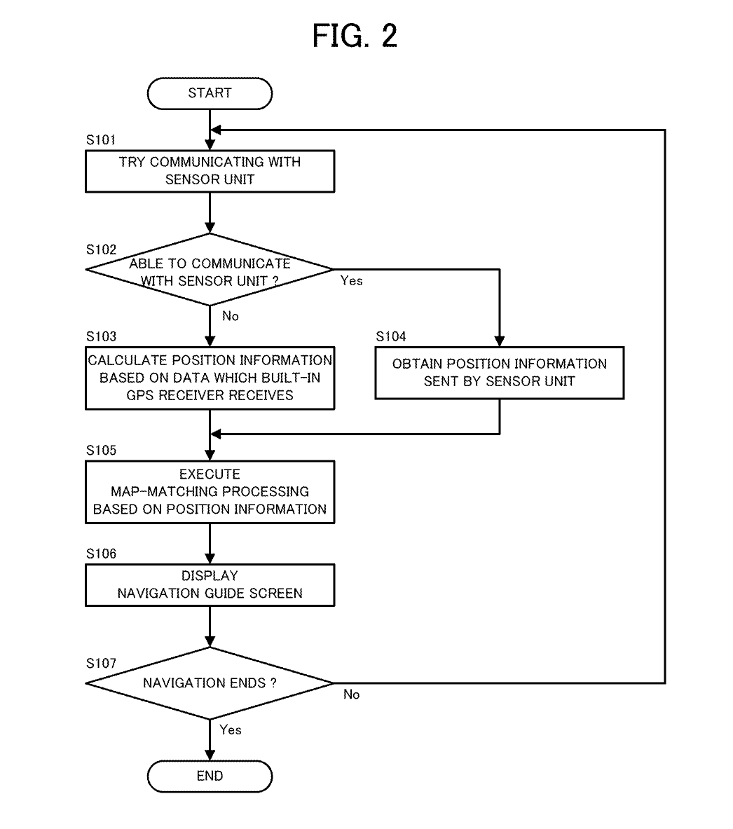

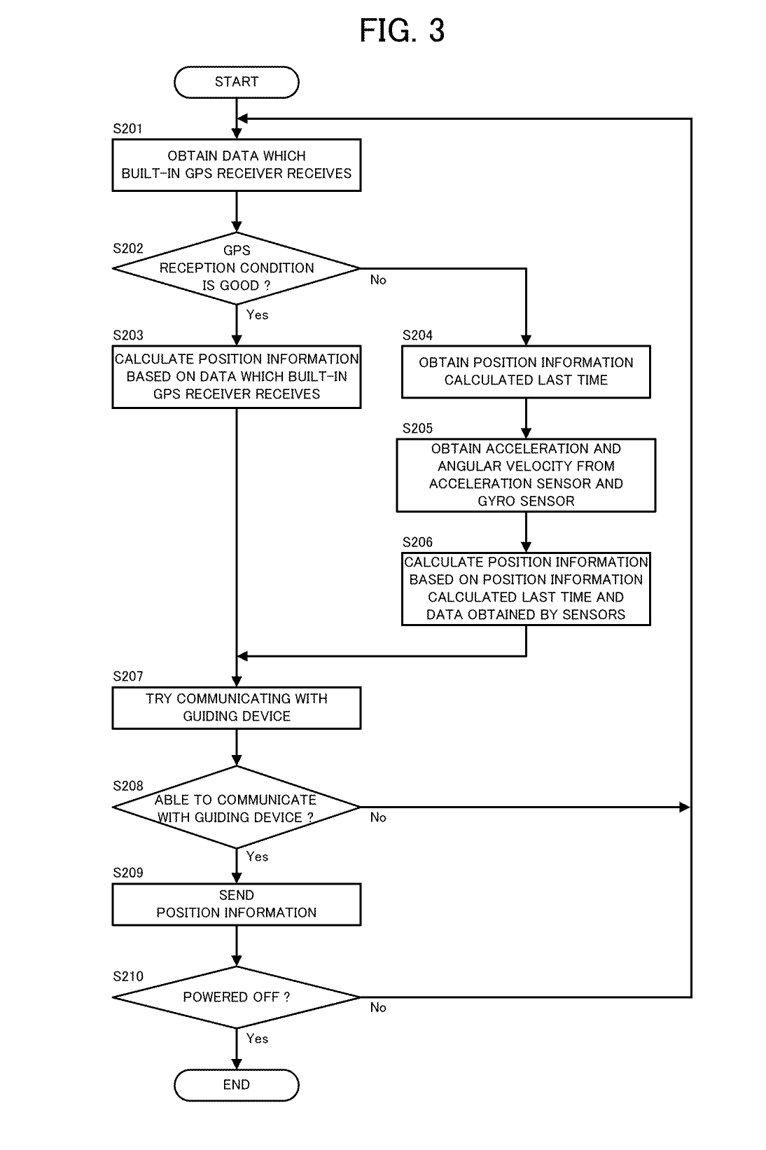

Next, a description will be given of a processing flow according to the first embodiment, with reference to FIG. 2 and FIG. 3.

FIG. 2 shows a processing flow executed by the controlling unit 11 in the guiding device 1. The processing flow starts when an application for the navigation stored in the guiding device 1 is run by the user. Additionally, the said processing is realized by the controlling unit 11, which executes the preliminarily stored program.

At first, in step S101, the controlling unit 11 tries communicating with the sensor unit 2 (specifically, the communication unit 23 in the sensor unit 2) via the communication unit 13. Then, the processing goes to step S102. In step S102, the controlling unit 11 determines whether or not it is possible to communicate with the sensor unit 2.

When it is not possible to communicate with the sensor unit 2 (step S102; No), the processing goes to step S103. In step S103, the controlling unit 11 calculates the position information based on the data which the GPS receiver 12 in the guiding device 1 receives. In this case, the controlling unit 11 also calculates the velocity, the direction and the acceleration based on the latitude and the longitude corresponding to the data which the GPS receiver 12 receives. Then, the processing goes to step S105.

Meanwhile, when it is possible to communicate with the sensor unit 2 (step S102; Yes), the processing goes to step S104. In step S104, the controlling unit 11 obtains the position information sent by the sensor unit 2. Specifically, the controlling unit 11 obtains the position information which the controlling unit 21 in the sensor unit 2 calculates based on the data which the GPS receiver 22 receives and the acceleration and the angular velocity detected by the acceleration sensor 25 and the gyro sensor 26. Then, the processing goes to step S105.

In step S105, the controlling unit 11 executes map-matching processing based on the position information obtained in step S103 or S104. The map-matching processing is processing for matching the position corresponding to the position information with the road by using a shape of the road in the map data so as to estimate the position on the road. Then, the processing goes to step S106.

In step S106, the controlling unit 11 displays a navigation guide screen in accordance with the position after the map-matching processing in step S105. Specifically, the controlling unit 11 displays the guide root on the map in order to perform the route guide for the user. Then, the processing goes to step S107.

In step S107, the controlling unit 11 determines whether or not the application for the navigation ends. Specifically, the controlling unit 11 determines whether or not the application for the navigation ends by an operation of the user. When the application for the navigation ends (step S107; Yes), the processing ends. When the application for the navigation does not end (step S107; No), the processing returns to step S101.

Next, FIG. 3 shows a processing flow executed by the controlling unit 21 in the sensor unit 2. The processing flow starts when the sensor unit 2 is powered on. Namely, the processing flow starts when electric power from an accessory power source in the vehicle is supplied to the sensor unit 2 (i.e., when an engine starts). Additionally, the said processing is realized by the controlling unit 21, which executes the preliminarily stored program.

At first, in step S201, the controlling unit 21 obtains the data which the GPS receiver 22 in the sensor unit 2 receives. Then, the processing goes to step S202.

In step S202, the controlling unit 21 determines whether or not the GPS reception condition is good, based on the data obtained in step S201. For example, the controlling unit 21 evaluates the GPS reception condition, based on whether or not the number of acquired GPS satellites is larger than or equal to a predetermined value, and based on whether or not a distance error (i.e., position measurement error) of the GPS is smaller than or equal to a predetermined value, and based on whether or not a radio field strength of the GPS receiver 22 is larger than or equal to a predetermined value. In the example, when the number of the acquired GPS satellites is larger than or equal to the predetermined value, or when the distance error is smaller than or equal to the predetermined value, or when the radio field strength is larger than or equal to the predetermined value, the controlling unit 21 determines that the GPS reception condition is good.

When the GPS reception condition is good (step S202; Yes), the processing goes to step S203. In step S203, the controlling unit 21 calculates the position information based on the data which the GPS receiver 22 in the sensor unit 2 receives. In this case, the controlling unit 21 also calculates the velocity, the direction and the acceleration based on the latitude and the longitude corresponding to the data which the GPS receiver 22 receives. Then, the processing goes to step S207.

Meanwhile, when the GPS reception condition is not good (step S202; No), the processing goes to step S204. In step S204, the controlling unit 21 obtains the position information calculated last time. For example, the controlling unit 21 stores the position information in the storage unit 24 each time the controlling unit 21 calculates the position information, and reads out the position information stored in the storage unit 24 at the time of executing the processing in step S204. It is assumed that the position information obtained in step S204 includes both the position information calculated based on the data which the GPS receiver 22 receives (the said position information is calculated in step S203) and the position information calculated based on the acceleration and the angular velocity detected by the acceleration sensor 25 and the gyro sensor 26 (the said position information is calculated in step S206). After step S204, the processing goes to step S205.

In step S205, the controlling unit 21 obtains the acceleration and the angular velocity detected by the acceleration sensor 25 and the gyro sensor 26. Then, the processing goes to step S206.

In step S206, the controlling unit 21 calculates the present position information on the basis of the position information obtained in step S204, by using the acceleration and the angular velocity which are obtained in step S205. For example, the controlling unit 21 advances the position corresponding to the position information obtained last time by the distance in accordance with the velocity calculated by the acceleration, in the direction corresponding to the angular velocity, so as to calculate the present position information. Then, the processing goes to step S207.

In step S207, the controlling unit 21 tries communicating the guiding device 1 (specifically, the communication unit 13 in the guiding device 1) via the communication unit 23.

When it is possible to communicate with the guiding device 1 (step S208; Yes), the processing goes to step S209. In step S209, the controlling unit 21 sends the position information calculated in step S203 or S206, to the guiding device 1. Then, the processing goes to step S210. Meanwhile, when it is not possible to communicate with the guiding device 1 (step S208; No), the processing returns to step S201.

In step S210, the controlling unit 21 determines whether or not the sensor unit 2 is powered off. Namely, the controlling unit 21 determines whether or not the supply of the electric power from the accessory power source to the sensor unit 2 is stopped. When the sensor unit 2 is powered off (step S210; Yes), the processing ends. When the sensor unit 2 is not powered off (step S210; No), the processing returns to step S201.

According to the above first embodiment, compared to the configuration only using the GPS receiver 12 in the guiding device 1, the multiple GPS receivers can be used in accordance with the communication condition, and the position information can be obtained from the sensor unit 2 by the wireless communication. Therefore, it becomes possible to calculate the present position with accuracy. As a result, it becomes possible to suppress performing the guide of the navigation with the wrong timing and to suppress displaying the route from the wrong position.

Additionally, according to the first embodiment, when the user starts the engine in the vehicle from such a state that the user uses the navigation based on the GPS receiver 12 in the guiding device 1 at the time of walking, the sensor unit 2 starts operating, and then the sensor unit 2 sends the position information to the guiding device 1. Therefore, the user obtains the position information with accuracy without especially performing the operation.

Though the controlling unit 21 calculates the position information based on the data which the GPS receiver 22 in the sensor unit 2 receives in step S203, it is not limited to this. As another example, the controlling unit 21 can calculate the position information not only by using the data which the GPS receiver 22 receives but also by using the acceleration and the angular velocity detected by the acceleration sensor 25 and the gyro sensor 26 in addition to the position information calculated last time. Therefore, it becomes possible to calculate the position information with higher accuracy.

Additionally, when the position information calculated last time cannot be obtained in step S204 (i.e., when there is not the position information calculated last time), the controlling unit 21 can wait until the GPS reception condition becomes good and the position information is calculated based on the data which the GPS receiver 22 receives. Namely, the controlling unit 21 does not execute the processing for calculating the position information based on the acceleration and the angular velocity detected by the acceleration sensor 25 and the gyro sensor 26, until the position information is calculated based on the data which the GPS receiver 22 receives. In this case, after the position information is calculated based on the data which the GPS receiver 22 receives, the controlling unit 21 can calculate the position information on the basis of the position information calculated based on the said data, by using the acceleration and the angular velocity detected by the acceleration sensor 25 and the gyro sensor 26. For example, when the user firstly attaches the sensor unit 2 to the vehicle, there is not the position information calculated last time.

On the other hand, when the sensor unit 2 is attached to the vehicle again after the sensor unit 2 is removed from the vehicle (for example, when the sensor unit 2 is attached to different vehicle), since the position and the direction corresponding to the position information calculated last time tend to change, it can be said that the position information calculated last time should not be used. In this case, similar to such a case that there is not the position information calculated last time, the controlling unit 21 does not execute the processing for calculating the position information based on the acceleration and the angular velocity detected by the acceleration sensor 25 and the gyro sensor 26, until the position information is calculated based on the data which the GPS receiver 22 receives. If a switch which can detect a removal of the sensor unit 2 from the vehicle is provided with the sensor unit 2, the controlling unit 21 can execute the above processing when the switch detects the removal of the sensor unit 2 from the vehicle.

### Second Embodiment

Next, a description will be given of a second embodiment. In the first embodiment, when the guiding device 1 can perform the wireless communication with the sensor unit 2, the guiding device 1 uses the position information received from the sensor unit 2 without using the data which the GPS receiver 12 in the guiding device 1 receives. Meanwhile, in the second embodiment, when the GPS reception condition of the guiding device 1 is better than the GPS reception condition of the sensor unit 2, the guiding device 1 calculates the position information based on the data which the GPS receiver 12 in the guiding device 1 receives without using the position information received from the sensor unit 2, even when the guiding device 1 can perform the wireless communication with the sensor unit 2.

The reason is as follows. Since the antenna of the GPS receiver 22 in the sensor unit 2 is basically larger than the antenna of the GPS receiver 12 in the guiding device 1, the GPS reception condition of the sensor unit 2 tends to be better than that of the guiding device 1. However, there is a possibility that the GPS reception condition of the guiding device 1 is better than that of the sensor unit 2 immediately after the engine starts, for example. This is because, though the sensor unit 2 is powered on when the engine starts and the GPS receiver 22 starts receiving the data, the guiding device 1 continually receives the data by the GPS receiver 12 before the engine starts. Namely, this is because there is a possibility that the GPS reception condition of the sensor unit 2 is bad immediately after the engine starts.

Therefore, in the second embodiment, when the guiding device 1 can perform the wireless communication with the sensor unit 2, the guiding device compares the GPS reception condition of the guiding device 1 with the GPS reception condition of the sensor unit 2, and determines the GPS receiver used for calculating the position information based on the comparison result. Namely, the guiding device 1 calculates the position information by using the data of the GPS receiver included in one of the guiding device 1 and the sensor unit 2, the GPS reception condition of which is better than that of the other.

Specifically, when the GPS reception condition of the guiding device 1 is better than that of the sensor unit 2, the guiding device 1 uses the position information calculated based on the data which the GPS receiver 12 in the guiding device 1 receives. In contrast, when the GPS reception condition of the sensor unit 2 is better than that of the guiding device 1, the guiding device 1 uses the position information calculated based on the data which the GPS receiver 22 in the sensor unit 2 receives. Meanwhile, when the both the GPS reception condition of the guiding device 1 and the GPS reception condition of the sensor unit 2 are bad, the guiding device 1 uses the position information calculated based on the acceleration and the angular velocity detected by the acceleration sensor 25 and the gyro sensor 26 in the sensor unit 2.

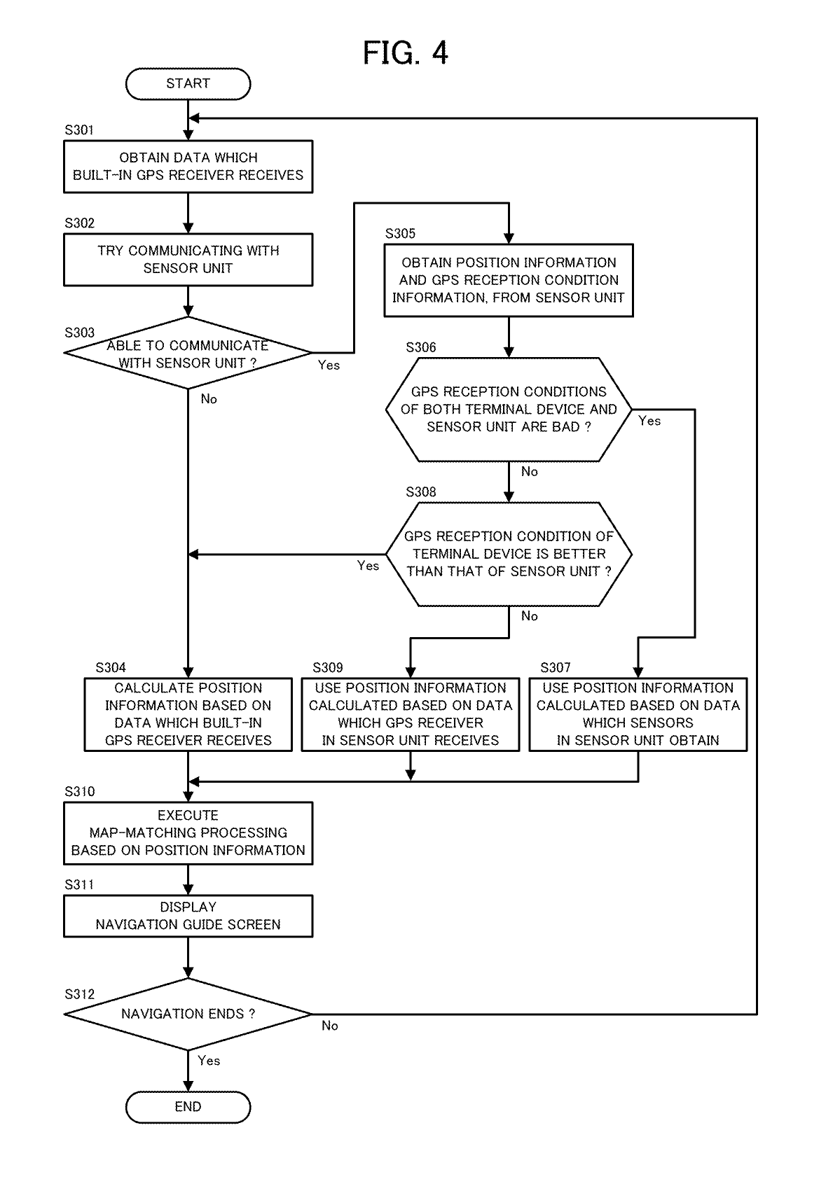

Next, a description will be given of a processing flow according to the second embodiment, with reference to FIG. 4. FIG. 4 shows the processing flow executed by the controlling unit 11 in the guiding device 1. The processing flow starts when the application for the navigation stored in the guiding device 1 is run by the user. Additionally, the said processing is realized by the controlling unit 11, which executes the preliminarily stored program.

At first, in step S301, the controlling unit 11 obtains the data which the GPS receiver 12 in the guiding device 1 receives. Then, the processing goes to step S302.

In step S302, the controlling unit 11 tries communicating with the sensor unit 2 (specifically, the communication unit 23 in the sensor unit 2) via the communication unit 13. Then, the processing goes to step S303. In step S303, the controlling unit 11 determines whether or not it is possible to communicate with the sensor unit 2.

When it is not possible to communicate with the sensor unit 2 (step S303; No), the processing goes to step S304. In step S304, the controlling unit 11 calculates the position information based on the data which the GPS receiver 12 in the guiding device 1 receives. In this case, the controlling unit 11 also calculates the velocity, the direction and the acceleration based on the latitude and the longitude corresponding to the data which the GPS receiver 12 receives. Then, the processing goes to step S310.

Meanwhile, when it is possible to communicate with the sensor unit 2 (step S303; Yes), the processing goes to step S305. In step S305, the controlling unit 11 obtains the position information and information (GPS reception condition information) indicating the GPS reception condition, which are sent by the sensor unit 2. In this case, the controlling unit 11 obtains both the position information which the controlling unit 21 in the sensor unit 2 calculates based on the data obtained from the GPS receiver 22 (the said position information is calculated in step S203 in FIG. 3) and the position information which the controlling unit 21 in the sensor unit 2 calculates based on the acceleration and the angular velocity detected by the acceleration sensor 25 and the gyro sensor 26 (the said position information is calculated in step S206 in FIG. 3). Then, the processing goes to step S306.

In step S306, the controlling unit 11 determines whether or not the GPS reception conditions of both the guiding device 1 and the sensor unit 2 are bad. In this case, the controlling unit 11 performs the determination, based on the data which the GPS receiver 12 in the guiding device 1 receives (the said data is obtained in step S301), and based on the information indicating the GPS reception condition of the GPS receiver 22 in the sensor unit 2 (the said information is obtained in step S305). For example, the controlling unit 11 evaluates the GPS reception condition, based on whether or not the number of the acquired GPS satellites is larger than or equal to a predetermined value, and based on whether or not the distance error (i.e., position measurement error) of the GPS is smaller than or equal to a predetermined value, and based on whether or not the radio field strength of the GPS is larger than or equal to a predetermined value.

When the GPS reception conditions of both the guiding device 1 and the sensor unit 2 are bad (step S306; Yes), the processing goes to step S307. In step S307, the controlling unit 11 determines to use the position information which the controlling unit 21 in the sensor unit 2 calculates based on the acceleration and the angular velocity detected by the acceleration sensor 25 and the gyro sensor 26 (the said position information is calculated in step S206 in FIG. 3). Then, the processing goes to step S310.

Meanwhile, the GPS reception conditions of both the guiding device 1 and the sensor unit 2 are not bad (step S306; No), namely the GPS reception condition of the guiding device 1 and/or the GPS reception condition of the sensor unit 2 is good, the processing goes to step S308. In step S308, the controlling unit 11 determines whether or not the GPS reception condition of the guiding device 1 is better than that of the sensor unit 2. In this case, the controlling unit 11 also performs the determination, based on the data which the GPS receiver 12 in the guiding device 1 receives (the said data is obtained in step S301), and based on the information indicating the GPS reception condition of the GPS receiver 22 in the sensor unit 2 (the said information is obtained in step S305). For example, the controlling unit 11 determines whether or not the GPS reception condition of the guiding device 1 is better than that of the sensor unit 2, based on whether or not the number of the acquired GPS satellites of the guiding device 1 is larger than that of the sensor unit 2, and based on whether or not the distance error of the guiding device 1 is smaller than that of the sensor unit 2, and based on whether or not the radio field strength of the guiding device 1 is smaller than that of the sensor unit 2.

When the GPS reception condition of the guiding device 1 is better than that of the sensor unit 2 (step S308; Yes), the processing goes to step S304. In this case, the controlling unit 11 calculates the position information based on the data which the GPS receiver 12 in the guiding device 1 receives without using the position information received from the sensor unit 2 (step S304). Then, the processing goes to step S310.

Meanwhile, when the GPS reception condition of the sensor unit 2 is better than that of the guiding device 1 (step S308; No), the processing goes to step S309. In step S309, the controlling unit 11 determines to use the position information which the controlling unit 21 in the sensor unit 2 calculates based on the data obtained from the GPS receiver 22 (the said position information is calculated in step S203 in FIG. 3). Then, the processing goes to step S310. It is assumed that the position information instep S309 includes not only the position information calculated based on only the data which the GPS receiver 22 receives but also the position information calculated by using the acceleration and the angular velocity detected by the acceleration sensor 25 and the gyro sensor 26 in addition to the data which the GPS receiver 22 receives.

Since the processing in steps S310 to S312 is the same as the processing in steps S105 to S107 shown in FIG. 2, description thereof will be omitted.

According to the above second embodiment, the guiding device 1 uses the data of the GPS receiver included in one of the guiding device 1 and the sensor unit 2, the GPS reception condition of which is better than that of the other. Therefore, it becomes possible to calculate the present position with higher accuracy.

When the GPS reception condition of the guiding device 1 is similar to the GPS reception condition of the sensor unit 2, it is preferable to use the position information sent by the sensor unit 2.

This is because, since the antenna of the GPS receiver 22 in the sensor unit 2 is basically larger than the antenna of the GPS receiver 12 in the guiding device 1, the GPS reception condition of the sensor unit 2 tends to become better than that of the guiding device 1. Additionally, as mentioned in the first embodiment, the sensor unit 2 being fixed to the vehicle calculates the position information by using the data which the GPS receiver 22 receives, and calculates the position information by using the acceleration and the angular velocity detected by the acceleration sensor 25 and the gyro sensor 26 in addition to the data which the GPS receiver 22 receives. Therefore, since the position information sent by the sensor unit 2 is calculated in consideration of the data detected by the various sensors in the sensor unit 2, it can be said that the said position information has high accuracy.

Though the second embodiment shows such an example that the guiding deice 1 selects any one of the position information calculated based on the data which the GPS receiver 12 in the guiding device 1 receives, the position information calculated based on the data which the GPS receiver 22 in the sensor unit 2 receives and the position information calculated based on the acceleration and the angular velocity detected by the acceleration sensor 25 and the gyro sensor 26 (see step S304, S307 and S309), it is not limited to this. The guiding device 1 may calculate the position information by combining the above three position information. As an example, the guiding device 1 can calculate the position information by averaging the three position information. As another example, the guiding device 1 can set a priority of each of the three position information, and can calculate the position information by combining the three position information in accordance with the priority. In the said example, the guiding device 1 can set the priority in accordance with the determination results in steps S306 and S308.

As still another example, the guiding device 1 can calculate the direction by using the angular velocity detected by the gyro sensor 26 in the sensor unit 2, and can calculate the position by using the data of the GPS receiver included in one of the guiding device 1 and the sensor unit 2, the GPS reception condition of which is better than that of the other. However, when the sensor unit 2 is attached to the vehicle again after the sensor unit 2 is removed from the vehicle (for example, when the sensor unit 2 is attached to different vehicle), the guiding device 1 does not use the position information sent by the sensor unit 2. The reason is as mentioned above. Basically, since the sensor unit 2 is not removed very often once the sensor unit 2 is fixed, the sensor unit 2 may be treated as a fixed object. For example, if a switch which can detect the removal of the sensor unit 2 from the vehicle is provided with the sensor unit 2 and the guiding device 1 receives a detecting signal of the switch from the sensor unit 2, the guiding device 1 can appropriately determine whether or not the position information (for example, the angular velocity detected by the gyro sensor 26) sent by the sensor unit 2 is used.

### Modified Examples

Next, a description will be given of modified examples.

### First Modified Example

A first modified example displays information as to whether to use the GPS receiver 12 in the guiding device 1 or the GPS receiver 22 in the sensor unit 2.

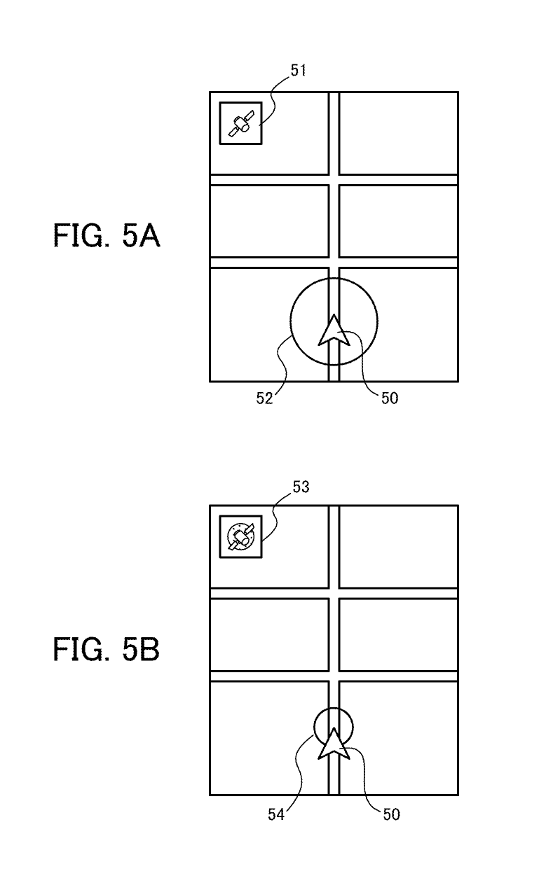

FIGS. 5A and 5B are diagrams showing display screens according to the first modified example. The display screens are displayed on the display unit 15 in the guiding device 1. FIG. 5A shows an example of the display screen when the GPS receiver 12 in the guiding device 1 is used. An image shown by a reference numeral 50 indicates the present position, and an image shown by a reference numeral 51 indicates that the GPS receiver 12 in the guiding device 1 is presently used. Additionally, a circle (hereinafter referred to as “error circle”) shown by a reference numeral 52 indicates the distance error (i.e., position measurement error) of the GPS. The error circle represents the GPS reception condition by a size of the circle (specifically, as the distance error becomes larger, the circle becomes larger), and indicates that the present position is located in the circle 99% of the time. In the example shown in FIG. 5A, since the error circle 52 is relatively large, the GPS reception condition is relatively bad.

FIG. 5B shows an example of the display screen when the GPS receiver 22 in the sensor unit 2 is used. An image shown by a reference numeral 50 indicates the present position, and an image shown by a reference numeral 53 indicates that the GPS receiver 22 in the sensor unit 2 is presently used. Additionally, a circle shown by a reference numeral 54 indicates an error circle. In the example shown in FIG. 5B, since the error circle 54 is relatively small, the GPS reception condition is relatively good.

By displaying the images shown in FIGS. 5A and 5B, the user can easily make out whether to use the GPS receiver 12 in the guiding device 1 or the GPS receiver 22 in the sensor unit 2, and can easily make out the GPS reception condition by the error circle.

It is not limited to display the information as to whether to use the GPS receiver 12 in the guiding device 1 or the GPS receiver 22 in the sensor unit 2, by the images 51 and 53 shown in FIGS. 5A and 5B. As another example, by changing a color and/or a mark of the image indicating the present position, the information as to whether to use the GPS receiver 12 in the guiding device 1 or the GPS receiver 22 in the sensor unit 2 can be displayed.

### Second Modified Example

In the above embodiments, the information is transmitted from the sensor unit 2 to the guiding device 1. Ina second modified example, the information is transmitted from the sensor unit 2 to the guiding device 1, and the information is transmitted from the guiding device 1 to the sensor unit 2. As an example, the guiding device sends the data which the GPS receiver 12 in the guiding device 1 receives, to the sensor unit 2. In the example, when the GPS reception condition of the GPS receiver 22 in the sensor unit 2 is bad, the sensor unit 2 can use the data which the GPS receiver 12 in the guiding device 1 receives.

As another example, the guiding device 1 sends the information of the direction and the velocity calculated based on the data which the GPS receiver 12 receives, to the sensor unit 2. In the example, the sensor unit 2 can calculate the position information by using the direction and the velocity received from the guiding device 1 in addition to the data detected by the acceleration sensor 25 and the gyro sensor 26.

According to the above second modified example, it becomes possible to calculate the preset position with higher accuracy.

### Third Modified Example

In the above embodiments, the position information is calculated based on the acceleration and the angular velocity detected by the acceleration sensor 25 and the gyro sensor 26. In a third modified example, the position information is calculated based on vehicle speed pulses obtained from the vehicle in addition to the acceleration and the angular velocity detected by the acceleration sensor 25 and the gyro sensor 26. Specifically, the sensor unit 2 obtains the vehicle speed pulses including a pulse signal generated with a wheel rotation of the vehicle. Then, the sensor unit 2 calculates a travel distance of the vehicle from the obtained vehicle speed pulses.

As still another example, the sensor unit 2 can calculate the position information by using information obtained by CAN (Controller Area Network). Namely, the sensor unit 2 can calculate the position information based on the information obtained by the CAN in addition to the acceleration and the angular velocity detected by the acceleration sensor 25 and the gyro sensor 26. For example, the sensor unit 2 can obtain a vehicle velocity and/or rotation amount of wheel (or a wheel velocity), so as to calculate the travel distance of the vehicle. When the information obtained by the CAN is used, the above vehicle speed pulses may be used. However, it is not necessary to use the vehicle speed pulses.

According to the above third modified example, by using the vehicle speed pulses and/or the information obtained by the CAN, it becomes possible to calculate the preset position with higher accuracy.

### Fourth Modified Example

In the above embodiments, the communication between the guiding device 1 and the sensor unit 2 is performed by the wireless communication. In a fourth modified example, the communication between the guiding device 1 and the sensor unit 2 is performed by a wire communication. Namely, the guiding device 1 may be connected to the sensor unit 2 by a wired connection.

### Fifth Modified Example

While the present invention is applied to a vehicle in the above description, the application of the present invention is not limited to this. The present invention may be applied to various movable bodies such as a ship, a helicopter and an airplane other than the vehicle. Additionally, the vehicle includes not only a four-wheel vehicle but also a two-wheel vehicle.

As described above, the embodiment is not limited to the embodiment described above, and may be alterable as needed without contradicting the gist and the idea of the invention readable from claims and specification in its entirety.

### INDUSTRIAL APPLICABILITY

The present invention can be used in a navigation device including a PND and a portable terminal device such as a cell-phone.

### DESCRIPTION OF REFERENCE NUMBERS

1 Guiding Device

2 Sensor Unit

11, 21 Controlling Unit

12, 22 GPS Receiver

13, 23 Communication Unit

14, 24 Storage Unit

15 Display Unit

25 Acceleration Sensor

26 Gyro Sensor

1. A position measurement device, comprising:
a first position detecting unit which detects a present position;
an obtaining unit which obtains a present position detected by a second position detecting unit that detects the present position, by a communication;
a detecting unit which detects a communication condition of the communication; and
an output unit which outputs either the present position detected by the first position detecting unit or the present position detected by the second position detecting unit, based on the communication condition.

2. The position measurement device according to claim 1, further comprising a comparing unit which compares reliability of a detection by the first position detecting unit with reliability of a detection by the second position detecting unit,
wherein the output unit outputs either the present position detected by the first position detecting unit or the present position detected by the second position detecting unit, based on the communication condition and a comparison result by the comparing unit.

3. The position measurement device according to claim 2, further comprising a supplementary information obtaining unit which obtains supplementary information that is supplementally used for detecting the present position, from a sensor unit which is fixed to a movable body and has the second position detecting unit,
wherein, when the reliability of the detection by the first position detecting unit is higher than the reliability of the detection by the second position detecting unit, the output unit outputs a present position based on the present position detected by the first position detecting unit and the supplementary information.

4. The position measurement device according to claim 3,
wherein the supplementary information includes information indicating a direction, and
wherein the output unit outputs the present position based on the present position detected by the first position detecting unit and the supplementary information, by using the direction included in the supplementary information as a present direction.

5. The position measurement device according to claim 1, further comprising a supplementary information obtaining unit which obtains supplementary information that is supplementally used for detecting the present position, from a sensor unit which is fixed to a movable body and has the second position detecting unit,
wherein, when the present position cannot be detected by the first position detecting unit and the second position detecting unit, the output unit outputs a present position based on present position information used last time and the supplementary information.

6. The position measurement device according to any one of claim 1,
wherein, the output unit outputs information as to whether to use the present position detected by the first position detecting unit or the present position detected by the second position detecting unit.

7. (canceled)

8. A position measurement method executed by a position measurement device, comprising:
a first position detecting process which detects a present position;
an obtaining process which obtains a present position detected by a second position detecting unit that detects the present position, by a communication;
a detecting process which detects a communication condition of the communication; and
an output process which outputs either the present position detected by the first position detecting process or the present position detected by the second position detecting unit, based on the communication condition.

9. A position measurement computer program product stored in a non-transient tangible computer-readable medium and executed by a position measurement device having a computer, the computer program product makes the computer function as:
a first position detecting unit which detects a present position;
an obtaining unit which obtains a present position detected by a second position detecting unit that detects the present position, by a communication;
a detecting unit which detects a communication condition of the communication; and
an output unit which outputs either the present position detected by the first position detecting unit or the present position detected by the second position detecting unit, based on the communication condition.

10. A portable terminal device, comprising:
a first position detecting unit which detects a present position by a GPS position measurement;
a displaying unit which displays a navigation guide screen;
a communication unit which is fixed to a movable body, and communicates with a sensor unit that includes a second position detecting unit which detects a present position by a GPS position measurement and a sensor which detects a condition of the movable body; and
a detecting unit which detects a communication condition with the sensor unit,
wherein, when the communication condition detected by the detecting unit is good, the portable terminal device uses position information calculated based on the present position detected by the second position detecting unit and/or the condition of the movable body detected by the sensor which are received from the sensor unit, at the time of displaying the navigation guide screen.

11. A sensor unit being fixed to a movable body, comprising:
a position detecting unit which detects a present position by a GPS position measurement;
a sensor which detects a condition of the movable body; and
a communication unit which communicates with a portable terminal device having a navigation function,
wherein the sensor unit calculates position information based on the present position detected by the position detecting unit and/or the condition of the movable body detected by the sensor, and sends the position information to the portable terminal device via the communication unit.
